(19) United States
(12) Patent Application Publication
(10) Pub. No.: US 2026/0073110 A1
(43) Pub. Date: Mar. 12, 2026

(54) ADDITIONAL PESSIMISM REMOVAL IN STATIC TIMING ANALYSIS

(71) Applicant: International Business Machines Corporation, Armonk, NY (US)

(72) Inventors: Aryan Garg, Bangalore (IN); Hemlata Gupta, Hopewell Junction, NY (US); Prabhat Kumar Maurya, Bangalore (IN); Manish Verma, Bangalore (IN); Kerim Kalafala, Rhinebeck, NY (US)

(21) Appl. No.: 18/828,109

(22) Filed: Sep. 9, 2024

(51) Int. Cl. G06F 30/3315; G06F 119/12

(52) U.S. Cl. CPC G06F 30/3315; G06F 2119/12

(57) ABSTRACT

Embodiments of the invention are directed to a computer-implemented method of analyzing timing constraints of a component-under-design (CUD). The computer-implemented method includes performing an initial iteration of a common path pessimism removal (CPPR) analysis on circuit elements of the CUD. The circuit elements includes inputs and outputs, and the circuit elements further include a transparent circuit element. The computer-implemented method further includes storing an initial list of the inputs and the outputs for which timing was adjusted during the initial iteration; and applying a second iteration of the CPPR analysis to the initial list of the inputs and the outputs.

### BACKGROUND

The present invention relates in general to electronic design tools used to assist in the design of integrated circuits. More specifically, the present invention relates to computing systems, computer-implemented methods, and computer program products that implement integrated circuit design techniques configured and arranged to reduce “additional” pessimism from common path pessimism removal performed during static timing analysis.

The layout of integrated circuits (ICs) must satisfy geometric requirements and the design's timing requirements and constraints. Timing analysis uses electronic computing tools and algorithms configured to validate the timing performance of an IC design by checking all possible paths for timing violations. “Electronic design automation” (EDA) refers to a suite of software, hardware and service tools that assists with the definition, planning, design, implementation, verification and subsequent manufacturing of semiconductor devices (or IC chips), including the performance of timing analysis. A type of timing analysis known as static timing analysis (STA) breaks an IC design into timing paths, calculates the signal propagation delay along each path, and checks for violations of timing constraints inside the IC design and at the input/output interface. To ensure proper post-fabrication functionality, IC design tools introduce additional margins in the form of pessimism during clock path analysis.

### SUMMARY

Embodiments of the invention provide a computer-implemented method of analyzing timing constraints of a component-under-design (CUD). The computer-implemented includes performing an initial iteration of a common path pessimism removal (CPPR) analysis on candidate circuit elements of the CUD. The candidate circuit elements include inputs and outputs. A subset of the candidate circuit elements includes a first circuit element and a second circuit element. An ability of the second circuit element to meet timing constraints of the CUD depends on the outputs of the first circuit element. An initial list of the inputs and the outputs for which timing performance was adjusted during the initial iteration is stored. A second iteration of the CPPR analysis is applied to the initial list of the inputs and the outputs.

Embodiments of the invention are also directed to computer systems and computer program products having substantially the same features as the computer-implemented methods described above.

Embodiments of the invention further provide a computer-implemented method of analyzing timing constraints of a component-under-design (CUD). The computer-implemented method includes performing a common path pessimism removal (CPPR) analysis on candidate circuit elements of the CUD. The candidate circuit elements includes inputs and outputs. A subset of the candidate circuit elements include a first circuit element and a second circuit element, where an ability of the second circuit element to meet timing constraints of the CUD depends on the outputs of the first circuit element. A list of candidate inputs having a timing performance that is a candidate for CPPR is stored. The list of the candidate inputs is sorted based at least in part on increasing arrival time (AT) levels associated with each of the candidate inputs of the list. For each of the candidate inputs of the list, beginning with a candidate input having a lowest AT level, applying a process that includes updating timing performance adjustments of an input-under-analysis (IUA); computing CPPR adjustments of the IUA; updating a required arrival time (RAT) associated with the CPPR adjustments; and invalidating timing performance adjustments of downstream inputs.

Embodiments of the invention are also directed to computer systems and computer program products having substantially the same features as the computer-implemented methods described above.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts an exemplary computing environment operable to implement aspects of the invention;

FIG. 2 depicts a simplified block diagram illustrating a timing analysis system operable to incorporate aspects of the invention;

FIG. 3 depicts a flow diagram illustrating a methodology operable to incorporate aspects of the invention;

FIG. 4 depicts a simplified block diagram illustrating “additional” or “unwanted” pessimism, which can be introduced through a common clock path, and which can be removed using aspects of the invention;

FIG. 5A depicts a simplified block diagram illustrating an integrated circuit (IC) design to which additional pessimism removal (APR) functionality can be applied in accordance with aspects of the invention;

FIG. 5B depicts a non-limiting example of how a transparent latch of the IC design shown in FIG. 5A can be implemented;

FIG. 5C depicts a diagram illustrating operation of the transparent latch shown in FIG. 5B;

FIG. 6A depicts a flow diagram illustrating a methodology operable to incorporate aspects of the invention;

FIG. 6B depicts a summary of the methodology shown in FIG. 6A;

FIG. 7 depicts a flow diagram illustrating a methodology operable to incorporate aspects of the invention;

FIG. 8 depicts a block diagram of a system capable of designing an IC using embodiments of the invention; and

FIG. 9 is a process flow of a method of fabricating an IC designed using embodiments of the invention.

In the accompanying figures and following detailed description of the disclosed embodiments, some of the elements illustrated in the figures are provided with reference numbers. In some instances, the leftmost digit of each reference number corresponds to the figure in which its element is first illustrated.

### DETAILED DESCRIPTION

Embodiments of the invention provide a computer-implemented method of analyzing timing constraints of a component-under-design (CUD). The computer-implemented includes performing an initial iteration of a common path pessimism removal (CPPR) analysis on candidate circuit elements of the CUD. The candidate circuit elements include inputs and outputs. A subset of the candidate circuit elements includes a first circuit element and a second circuit element. An ability of the second circuit element to meet timing constraints of the CUD depends on the outputs of the first circuit element. An initial list of the inputs and the outputs for which timing performance was adjusted during the initial iteration is stored. A second iteration of the CPPR analysis is applied to the initial list of the inputs and the outputs.

The above-described features provide technical effects and/or technical benefits. For example, the embodiments of the invention provide an iterative CPPR approach that performs an initial iteration of a CPPR analysis on candidate circuit elements of the CUD, where the candidate circuit elements includes inputs and outputs. As used herein, the modifier “candidate” refers to a specific signal or net or element within a circuit that is identified as a potential focus for timing analysis. Candidates are selected based on their importance in meeting timing constraints, such as setup time, hold time, and clock period requirements. A subset of the candidate circuit elements includes first and second circuit elements that are dependent on one another (i.e., interdependent) in that the second circuit element's timing performance is dependent on outputs from first circuit element. Due at least in part to this dependency relationship, embodiments of the invention perform timing constraints analysis that takes into account the impact that the first circuit has on the timing performance of the second circuit. By implementing an iterative approach to timing constraint analysis, embodiments of the invention remove the additional pessimism created due to the interdependency of the first and second circuit elements. The iterative features of embodiments of the invention enable the processing of changes in timing constraints between the first and second circuit elements due to the interdependency of the first and second circuit element, and further ensure that the pins of circuit elements that are downstream from the first circuit element will be processed with the updated timing constraints.

In addition to any one or more of the features described herein, the initial iteration of the CPPR analysis is performed substantially in parallel on each of the candidate circuit elements of the CUD.

The above-described features provide further technical effects and/or technical benefits. For example, the substantially in parallel or multi-threaded application of the iterations of the CPPR analysis improves processing speed and reduces processing time to improve overall IC design runtime and throughput.

In addition to any one or more of the features described herein, the computer-implemented method further includes, responsive to the second iteration of the CPPR analysis, storing a second list of the inputs and the outputs for which timing performance was adjusted during the second iteration.

The above-described features provide technical effects and/or technical benefits. For example, due at least in part to the dependency relationship between the first and second circuit elements, embodiments of the invention perform timing constraints analysis that takes into account the impact that the first circuit has on the timing performance of the second circuit. By implementing an iterative approach to timing constraint analysis, embodiments of the invention remove the additional pessimism created due to the interdependency of the first and second circuit elements. The iterative features of embodiments of the invention enable the processing of changes in timing constraints between the first and second circuit elements due to the interdependency of the first and second circuit element, and further ensure that the pins of circuit elements that are downstream from the first circuit element will be processed with the updated timing constraints.

In addition to any one or more of the features described herein, the computer-implemented method further includes, responsive to a determination that a maximum number of iterations of the CPPR analysis have been performed, ending the computer-implemented method.

The above-described features provide technical effects and/or technical benefits. For example, by implementing the iterative timing constraint analysis up to a maximum number of iterations or until no change in the timing performance is required, we can handle multiple levels of interdependency.

In addition to any one or more of the features described herein, the computer-implemented method further includes, responsive to a determination that none of the inputs and none of the outputs received timing performance adjustments during an iteration of the CPPR analysis applied to the candidate circuit elements of the CUD.

The above-described features provide technical effects and/or technical benefits. For example, by implementing the iterative timing constraint analysis up to a maximum number of iterations or until no change in the timing performance is required, we can handle multiple levels of interdependency.

In addition to any one or more of the features described herein, the first circuit element includes a transparent circuit element.

The above-described features provide technical effects and/or technical benefits. For example, due at least in part to the dependency relationship between the first and second circuit elements, embodiments of the invention perform timing constraints analysis that takes into account the impact that the first circuit has on the timing performance of the second circuit. By implementing an iterative approach to timing constraint analysis, embodiments of the invention remove the additional pessimism created due to the interdependency of the first and second circuit elements. The iterative features of embodiments of the invention enable the processing of changes in timing constraints between the first and second circuit elements due to the interdependency of the first and second circuit element, and further ensure that the pins of circuit elements that are downstream from the first circuit element will be processed with the updated timing constraints.

In addition to any one or more of the features described herein, the transparent circuit element includes a transparent latch that is operable to pass data while a clock signal applied to the transparent latch is active.

The above-described features provide technical effects and/or technical benefits. For example, due at least in part to the dependency relationship between the first and second circuit elements, embodiments of the invention perform timing constraints analysis that takes into account the impact that the first circuit has on the timing performance of the second circuit. By implementing an iterative approach to timing constraint analysis, embodiments of the invention remove the additional pessimism created due to the interdependency of the first and second circuit elements. The iterative features of embodiments of the invention enable the processing of changes in timing constraints between the first and second circuit elements due to the interdependency of the first and second circuit element, and further ensure that the pins of circuit elements that are downstream from the first circuit element will be processed with the updated timing constraints.

Embodiments of the invention are also directed to computer systems and computer program products having substantially the same features, technical effects, and technical benefits as the computer-implemented methods described above.

Embodiments of the invention further provide a computer-implemented method of analyzing timing constraints of a component-under-design (CUD). The computer-implemented method includes performing a common path pessimism removal (CPPR) analysis on candidate circuit elements of the CUD. The candidate circuit elements include inputs and outputs. A subset of the candidate circuit elements includes a first circuit element and a second circuit element, where an ability of the second circuit element to meet timing constraints of the CUD depends on the outputs of the first circuit element. A list of candidate inputs having a timing performance that is a candidate for CPPR is stored. The list of the candidate inputs is sorted based at least in part on increasing arrival time (AT) levels associated with each of the candidate inputs of the list. For each of the candidate inputs of the list, beginning with a candidate input having a lowest AT level, applying a process that includes updating timing performance adjustments of an input-under-analysis (IUA); computing CPPR adjustments of the IUA; updating a RAT associated with the CPPR adjustments; and invalidating timing performance adjustments of downstream inputs.

The above-described features provide technical effects and/or technical benefits. For example, using the above-described feature provide a “levelized” approach to performing a CPPR analysis on candidate circuit elements of the CUD. The approach is levelized in that analysis is performed on a list of the inputs for which timing was a candidate for CPPR and the list of candidate inputs is sorted based at least in part on increasing AT levels. The process iterates through the candidate inputs of the list, beginning with the input having a lowest AT level, and applying a process that includes computing CPPR adjustments and updating the timing. The levelized APR approach works in a levelized manner, i.e., all of the candidate pins are processed in increasing order of their AT levels. As previously noted, the AT level is the relative order of a pin in a timing graph from left to right. As the levelized APR approach moves from one AT level to another, the timing is dynamically updated until that level and the next level pins are analyzed for CPPR with the updated timing. Operating the levelized approach in this manner allows the approach to process multiple levels of interdependency among the candidate circuit elements of the CUD, which improves processing speed and efficiency by further minimizing the need for recalculation of common path pessimism values.

In addition to any one or more of the features described herein, the first circuit element includes a transparent latch, and the transparent latch is operable to pass data while a clock signal applied to the transparent latch is active.

The above-described features provide technical effects and/or technical benefits. For example, using the above-described feature provide a “levelized” approach to performing a CPPR analysis on candidate circuit elements of the CUD. The approach is levelized in that analysis is performed on a list of the inputs for which timing was a candidate for CPPR and the list of candidate inputs is sorted based at least in part on increasing AT levels. The process iterates through the candidate inputs of the list, beginning with the input having a lowest AT level, and applying a process that includes computing CPPR adjustments and updating the timing. The levelized APR approach works in a levelized manner, i.e., all of the candidate pins are processed in increasing order of their AT levels. As previously noted, the AT level is the relative order of a pin in a timing graph from left to right. As the levelized APR approach moves from one AT level to another, the timing is dynamically updated until that level and the next level pins are analyzed for CPPR with the updated timing. Operating the levelized approach in this manner allows the approach to process multiple levels of interdependency among the candidate circuit elements of the CUD, which improves processing speed and efficiency by further minimizing the need for recalculation of common path pessimism values.

Embodiments of the invention are also directed to computer systems and computer program products having substantially the same features, technical effects, and technical benefits as the computer-implemented methods described above.

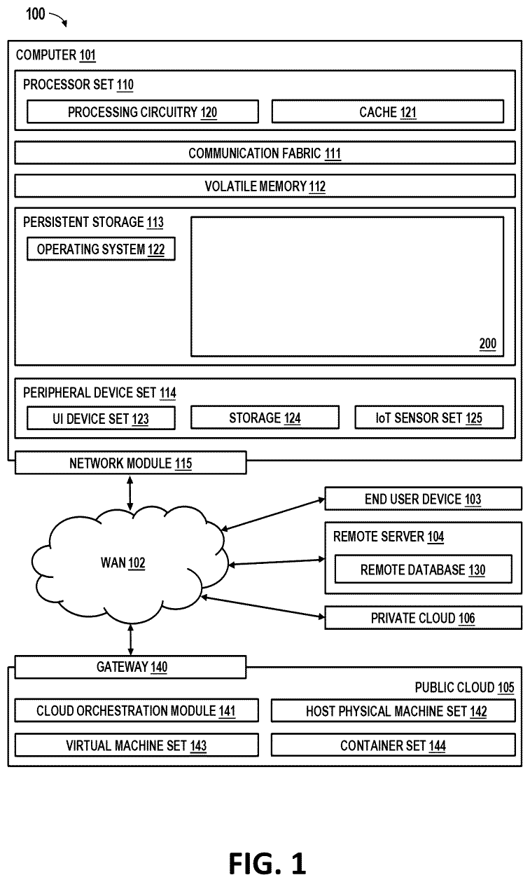

Turning not to an overview of technologies that are relevant to and support embodiments of the invention, in complex and dense ICs (e.g., high-speed very large scale integrated (VLSI) ICs), thousands to millions of transistors and other devices are present on a single chip, and these ICs/chips are configured to implement complex structures/functions, such as microprocessors, memory chips, or system-on-chip (SoC) designs. Because it is not practical or, under some circumstances, not possible to manually execute the design tasks (e.g., signal timing, metal density, signal integrity, and the like) required for acceptable design & manufacturing runtimes to create complex and dense ICs, software/hardware known as “electronic design automation” (EDA) tools have been developed. As previously noted herein, EDA refer to a suite of software, hardware and service tools that assists with the definition, planning, design, implementation, verification and subsequent manufacturing of semiconductor devices (or IC chips), including the performance of timing analysis. EDA tools are used to design, validate and verify the semiconductor manufacturing process to ensure it delivers the required performance and density. In accordance with aspects of the invention, EDA tools can be implemented using any appropriate combination of the features and functionality depicted by the computing environment 100 (shown in FIG. 1).

Static Timing Analysis (STA) is a method used in IC design to verify that the relevant circuits meet their timing requirements without requiring dynamic simulation. In STA, timing characteristics of the IC are analyzed by examining the paths between flip-flops and gates to ensure that signals are propagated and captured correctly. STA checks for timing constraints like setup time, hold time, and clock period across all possible paths, thereby providing insights into potential timing issues such as critical paths and negative slack.

STA techniques can represent an IC design as a timing graph. The points in the IC design where timing information is desired constitute the nodes or timing points of this graph, while electrical or logic connections between these nodes are represented as timing arcs of the graph. STA is performed typically at the logic gate level using lookup-table based gate timing libraries and involves some runtime expensive circuit simulation for timing calculation of wires and gates using current source model based timing libraries.

The optimization process that meets timing requirements and constraints is often called timing closure. Timing closure procedures design and optimize an IC design such that applied electrical signals can traverse through the IC within the specified timing constraints. An IC design must achieve timing closure prior to manufacturing. STA techniques are used to guide and validate the completion of timing closure.

STA techniques and systems model various sub-circuity of an IC design at pre-manufacturing stages (e.g., during a floor-planning stage) to ensure that the IC design(s) can run at the design-required timing frequencies. In STA, the terms “arrival time” (AT) and equivalents thereof refer to estimates of the time at which data transmitted in accordance with the IC design actually arrives at its target location. The terms “required arrival time” (RAT) and equivalents thereof refer to the time at which data is required by the IC design to arrive at its target location. The term “slack” and equivalents thereof are used to identify the difference between RAT and AT.

In STA, “late mode” test analysis evaluates the timing behavior of an IC by considering the worst-case scenario for signal arrival times. In a late mode test analysis, negative slack (AT>RAT) means that data arrives too late and can be lost or can result in delays while the system performs data error correction. Positive slack (AT<RAT) in late mode within an acceptable range means data will arrive on time. In STA, “early mode” test analysis ensures that data signals arrive at flip-flops or registers with enough time before the clock edge to meet setup time requirements. By verifying that setup time constraints are satisfied, early mode analysis helps prevent timing issues that could lead to incorrect data being latched or captured. For early mode test analysis, negative slack that is outside an acceptable range means data will arrive too soon and therefore will overwrite data intended for previous cycle. Negative slack in the design requires corrective IC design changes such as additional circuit buffers, rearranged wiring, and the like.

Because modern chip manufacturing technology is scaling to sub-45 nanometers, VLSI designs are increasingly larger in terms of size and complexity. Application specific integrated circuit (ASIC) designs contain several to a few hundred million logic gates. Performance centric designs, especially microprocessor designs, include custom-designed circuit components to achieve aggressive frequency targets and can contain upwards of one billion transistors. STA performed for these designs would ideally employ circuit simulators for obtaining accurate timing calculations. However, the run-time intensive nature of circuit simulation is impractical for large designs, especially where timing runs are made daily during the design cycle of the chip. In essence, performing STA on modern large circuits as a single flattened design is run-time prohibitive. This has led to the development of a hierarchical timing flow where a circuit design is partitioned into components. A component can be partitioned further into sub-components in a recursive fashion. As an example, a typical microprocessor design is partitioned into several components called cores, each core is partitioned into components termed units, and each unit is partitioned into components termed microchips or macros. Illustratively, a core level of hierarchy can contain a set of units connected using wires and additional gates that may or may not be part of any component. Similarly, a unit level of hierarchy can contain a set of macros connected using wires and additional gates that may or may not be part of any component. For ease of notation, the term “component” will be used in this detailed description to refer to a sub-component or component (e.g. a macro, a unit, or a core).

A printed circuit board (PCB) houses components, and each component has input/output (I/O) lines that transmit and receive data under the coordination of various clock signals. Clock signals are generated by a circuit's clock generation and distribution systems that are designed to control how the clock signals impose various timing requirements dictated by the relevant circuit design(s). In general, clock signals are used to coordinate the actions of two or more circuits, including, for example, coordinating data transmissions between one component and another component. In instances where there is a hierarchical relationship between the components, the component that sets the requirements (e.g., timing requirements or constraints) for another component is known as the “parent,” and the component that has its requirements (e.g., timing requirements or constraints) set by another component is known as the “child.” The clock signal oscillates between a high and a low state with a selected duty cycle (e.g., a 50% duty cycle) and is usually a square wave. The clock signal effectively defines when a component performs an operation or instruction. A clock cycle can be defined as the high-low-high transition of the clock signal, and the various operations or functions performed under control of the clock signal can be evaluated in terms of the number of clock cycles the operation or function takes to complete. For example, a child component can take one clock cycle to move data from the child component to one of its parent components, but a different child component can take two clock cycles to perform the same operation.

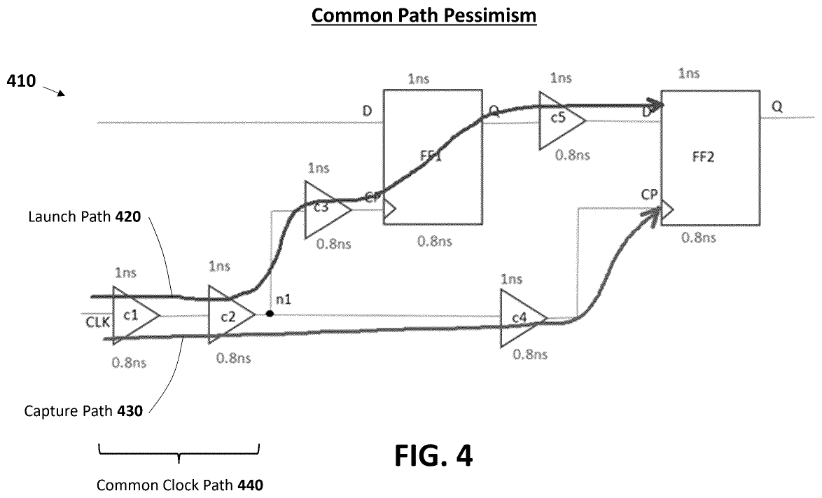

To ensure proper post-fabrication functionality, electronic IC design tools (e.g., EDA tools) introduce additional margins in the form of pessimism during clock path analysis. Timing pessimism, also known as clock pessimism, accounts for the maximum and minimum delay variation of common clock paths. Common clock paths can occur when two different delay values are used for the same clock path. In a simple setup analysis, the maximum clock path delay to the source register is used to determine the data AT, while the minimum clock path delay to the destination register is used to determine the data RAT. A non-limiting example of common clock path pessimism is depicted in FIG. 4 and described in greater detail subsequently herein.

A small amount of pessimism can be helpful in meeting the timing of an IC design. However, too much pessimism can increase the effort required by an IC design tool to fix critical timing paths, and it can negatively impact other parameters like power and area. Common path pessimism removal (CPPR) refers to computer-implemented tools or algorithms that account for the minimum and maximum delay variation associated with common clock paths during STA by adding the difference between the maximum and minimum delay value of the common clock path to the appropriate slack equation.

Known CPPR algorithms work independently on all the candidate pins in the IC and apply CPPR credit to them if common nodes are found in the clock path of the launch and capture latch. A “candidate pin” refers to a pin on a digital circuit or chip that is selected for timing checks and analysis because the pin is a part of the circuit where timing is most critical. In general, a given CPPR algorithm can use a slack cut-off to identify the candidate pins. The slack cut-off ensures that the timing analysis focuses on the most critical paths and pins by setting a threshold for slack, thereby improving the efficiency of the timing verification process and ensuring that the most important timing issues are addressed. For candidate pins that have multiple common paths, the CPPR algorithm can be configured to report the path having worst negative slack after the complete analysis. To gain performance for setup test, a CPPR algorithm can provide CPPR credit only to improve the slack beyond cut-off even if there is scope or room for more credit. “CPPR credit” refers to the recognition or allowance given to the improvements achieved through CPPR techniques. When a critical path is optimized and certain improvements are validated, the IC design might earn “credits” for these improvements.

IC designs include multiple components, including storage elements such as latches. A latch can be transparent (i.e., clock level triggered) or non-transparent (i.e., clock edge triggered). A non-transparent latch only latches the outputs with a copy of the inputs on a designated clock edge (or a clock transition). A transparent latch allows its outputs to follow its inputs while the latch is in the active state (i.e., the clock sign is high or low depending on the type of latch). With the use of one or more transparent latches in series with a common clock path bounding, CPPR algorithms can leave some additional pessimism in the IC design in that the CPPR timing adjustments on two separate pins are no longer independent. CPPR credit on one pin can impact the slacks on other downstream latches that can change the amount of CPPR credit given to already eligible pins. CPPR credit on one pin can also make more pins eligible for CPPR analysis by bringing them under the cut-off.

Embodiments of the invention provide computing systems, computer-implemented methods, and computer program products (e.g., EDA tools) that implement IC design techniques configured and arranged to reduce “additional” pessimism from CPPR operations performed during STA. Some embodiments of the invention provide an “iterative” additional pessimism removal (APR) approach to remove unneeded or unwanted pessimism from a timing analysis. The APR is iterative in that it is repeatedly applied, and results are refined and/or improved with each iteration. Each cycle of the APR approach involves reviewing outcomes, making adjustments, and reapplying the process until the desired outcome is achieved. In accordance with embodiments of the invention the iterative APR approach includes running CPPR iteratively many times on an IC design until the additional pessimism is removed or a defined iteration limit is reached. The iterative APR approach is operable to leverage the technical benefits of incremental and parallel processing support for both timing and CPPR analysis, which will significantly reduce the runtime and memory of the iterations. In the context of this invention, incremental timing refers to a situation where we have performed an initial timing analysis, followed by the recognition of an occurrence of a change in the design or in adjustment (such as a CPPR adjust) which can impact said initial timing results, and then the recalculation of timing values as needed in order to bring timing up-to-date with respect to said changes that have occurred since said initial timing. In accordance with embodiments of the invention, the first iteration of the APR approach is operable to compute CPPR adjustments in parallel on all of the candidate pins, and the subsequent iterations will run incrementally and in parallel but only on those pins on which timing was updated due to the previous iteration. CPPR uses a user-defined slack cut-off to identify the candidate pins. A candidate pin means there should be at least a test associated with it and the slack of that test should be less than the CPPR slack cut-off.

Some embodiments of the invention provide a levelized APR approach to remove unneeded or unwanted pessimism from a timing analysis. A levelized APR approach in accordance with aspects of the invention includes one iteration to update the whole timing. The levelized APR approach works in a levelized manner, i.e., all of the candidate pins are processed in increasing order of their AT levels. As previously noted, the AT level is the relative order of a pin in a timing graph from left to right. As the levelized APR approach moves from one AT level to another, the timing is dynamically updated until that level and the next level pins are analyzed for CPPR with the updated timing.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Many of the functional units of the systems described in this specification have been labeled as modules. Embodiments of the invention apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together but can include disparate instructions stored in different locations which, when joined logically together, function as the module and achieve the stated purpose for the module.

The components/modules of the systems illustrated herein are depicted separately for ease of illustration and explanation. In embodiments of the invention, the functions performed by the components/modules can be distributed differently than shown without departing from the scope of the various embodiments of the invention describe herein unless it is specifically stated otherwise.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 1 depicts a computing environment 100 that contains an example of an environment for the execution of at least some of the computer code involved in performing the inventive methods, such as code block 200 operable to implement the novel additional pessimism removal (APR) functionality described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Turning now to an overview of technologies that are relevant to embodiments of the invention, the terms “electronic design automation” (EDA) refer to a suite of software, hardware and service tools that assists with the definition, planning, design, implementation, verification and subsequent manufacturing of semiconductor devices (or IC chips). EDA tools are used to design, validate and verify the semiconductor manufacturing process to ensure it delivers the required performance and density. In accordance with aspects of the invention, EDA tools can be implemented using any appropriate combination of the features and functionality of the computing environment 100 (shown in FIG. 1).

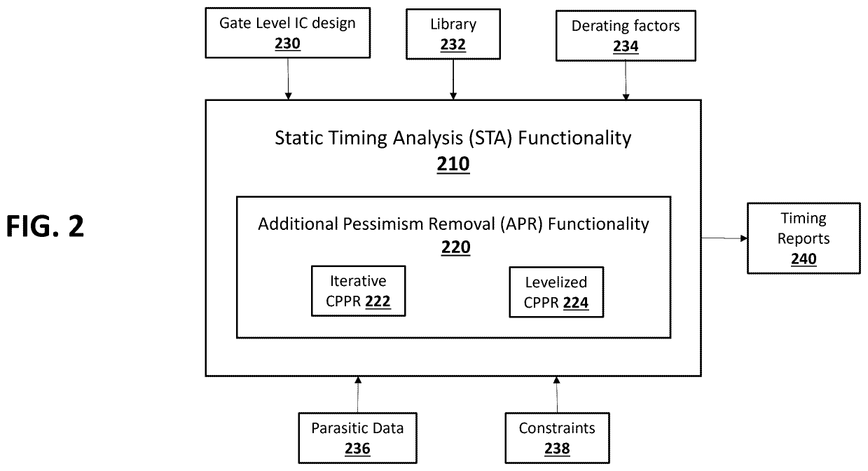

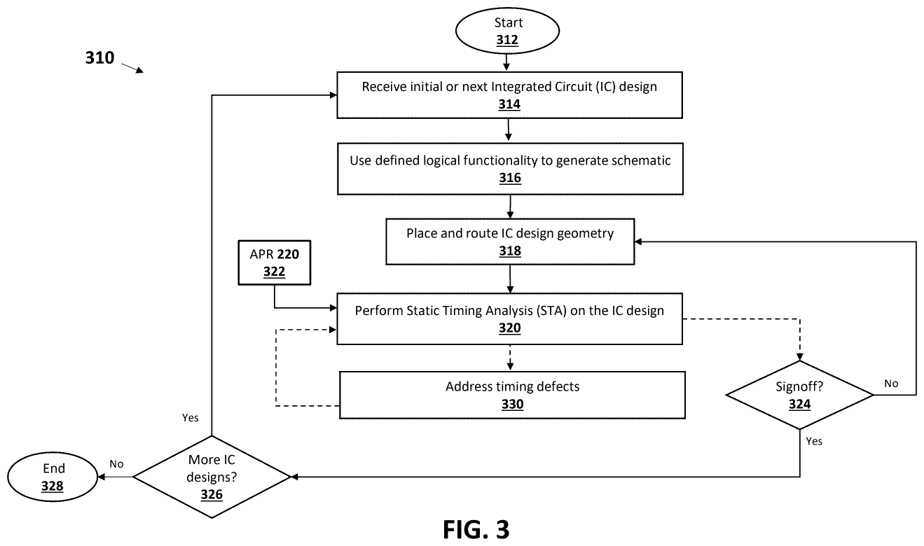

An overview of EDA methodologies and tools that can be utilized to implement aspects of the invention will now be provided. FIG. 2 depicts a simplified block diagram illustrating STA functionality 210 having additional pessimism removal (APR) functionality 220 operable to incorporate aspects of the invention; and FIG. 3 depicts a flow diagram illustrating a computer-implemented methodology 310 that incorporates the STA functionality 210 and the APR functionality 220 in accordance with aspects of the invention.

As seen in FIG. 2, a gate level netlist definition of an IC design (gate level IC design 230, also referred to herein as IC design 230) is incorporated via loading or reading into the STA functionality module 210. A standard cell timing library 232 is also incorporated into the STA functionality module 210 to build a model of the IC design, such as a timing graph, where each component pin is represented as a node of the timing model and each interconnect is represented by a path segment (timing arc, edge or link) between nodes. The STA functionality module 210 is also operable to accept, as inputs for various sub-analyses or responsive to configured options for execution, a number of data sources representing various aspects of the IC design, including, for example derating factors 234, parasitic data 236, and constraints 238 (also referred to herein as requirements 238). After the various data inputs 230, 232, 234, 236, 238 are input to the STA functionality module 210, a timing graph model of the IC circuit design is built to include the various data inputs 230, 232, 234, 236, 238.

The STA functionality 210 is then executed to analyze the timing graph of the IC design, which generates the timing reports 240 (e.g., a timing database). The timing reports 240 can be used in further analysis and violation remediation downstream, such as in a downstream optimizer operable to modify portions of the IC design to address timing violations. Throughout the operations of the STA 210, a set of required times are determined based at least in part upon user-specified constraints (e.g., constraints 238), and also based at least in part on required synchronization between sequential components of the IC such as flip flops, registers, latches, and the like. For example, a launch and capture flip flop pair is expected to transmit a data element on a clock edge from the launch to the capture flip flop. In this regard, implied constraints beyond those explicitly defined exist due to the high degree of coordination required to synchronize launching flip flop, clock, and capturing flip flop. The capture flip flop must be ready and waiting for the launching flip flop to send the data item thereto for a successful transfer of data from launching flip flop to capture flip flop. For a given IC design/device to function as intended, all such timing constraints must be met.

In accordance with aspects of the invention, executing the STA functionality 210 includes executing the APR functionality 220, which includes an iterative CPPR functionality 222 and a levelized CPPR functionality 224, both in accordance with embodiments of the invention. Embodiments of the invention provide the APR functionality 220 configured and arranged to reduce “additional” pessimism from CPPR operations performed during performance of the STA functionality 210. In some embodiments of the invention, the iterative CPPR functionality 222 provides an “iterative” approach to remove unneeded or unwanted pessimism from a timing analysis. In accordance with embodiments of the invention, the iterative approach includes running CPPR iteratively many times on an IC design until the additional pessimism is removed or a defined iteration limit is reached. The iterative APR approach is operable to leverage the benefits of incremental and parallel processing support for both timing and CPPR analysis, which will significantly reduce the runtime and memory of the iterations. The first iteration is operable to compute CPPR adjustments on all the candidate pins, and the subsequent iterations will run incrementally only on those pins on which timing was updated due to the previous iteration.

In some embodiments of the invention, the APR functionality 220 is implemented using a “levelized” APR approach to remove unneeded or unwanted pessimism from a timing analysis. The levelized approach can be the levelized CPPR functionality 224, includes the use of one iteration to update the whole timing. The levelized APR approach (i.e., the levelized CPPR functionality 224) works in a levelized manner, i.e., all of the candidate pins are processed in increasing order of their AT levels. As previously noted, the AT level is the relative order of a pin in a timing graph from left to right. As the levelized approach moves from one AT level to another, the timing is dynamically updated until that level and the next level pins are analyzed for CPPR with the updated timing.

FIG. 3 depicts a flow diagram illustrating a computer-implemented methodology 310 (also referred to herein as methodology 310) operable to be performed by an EDA tool that includes the STA functionality 210 (shown in FIG. 2). The methodology 310 starts at block 312 then moves to block 314 to receive an initial or next IC design. The IC design is conceived and elaborated typically through numerous computer-aided stages to arrive at a physical IC design layout. At block 316, the defined logical functionality is used to refine the conceived design idea to define logical functionality and generate a logical schematic of the IC design. At block 318, the largely qualitative logical schematic design generated at block 316 is further refined or elaborated upon to place and route a specific physical geometry and coordinates of each individual gate or element of the IC design with interconnects defined therebetween. The operations at block 318 result in the generation of a physical layout of the IC design. At block 320, a so-called sign-off process is initiated to ensure proper operational timing of the IC design by performing STA on the IC design, using, for example, the STA functionality 210 (shown in FIG. 2) and the APR functionality 220 (shown in FIG. 2). In embodiments of the invention, the APR functionality 220 can be implemented using the iterative CPPR functionality 222 (shown in FIG. 2) and/or the levelized CPPR functionality 224 (shown in FIG. 2).

In at least an initial iteration of the methodology 310, after the STA and APR operations at blocks 320, 322, a set of nodes and their resultant operational timing characteristics are passed on to block 330, which performs operations to address timing defects in the IC design. In some embodiments of the invention, block 330 is operable to use, for example, a physical circuit optimizer of the EDA tool in a transformative manner to address timing defects of the IC design by insertion, deletion, or modification of gates in the IC design. Modifications to the IC design are generally made by edits to the gate level netlist definition of the IC design (i.e., the gate level IC design 230 shown in FIG. 2). Upon conclusion of the operations at block 330, the methodology 310 returns to block 320 (and block 322) to again perform STA and/or APR operations. After the repeat execution of block 320 (and block 322), the methodology 310 moves to decision block 324 to evaluate whether all violations are resolved and the IC design can be signed off. If the answer to the inquiry at decision block 324 is no, the methodology 310 returns to block 318 to redo the operations at blocks 318, 320, 322, and 330. If the answer to the inquiry at decision block 324 is yes, the methodology 310 moves to decision block 326 to evaluate whether or not there are more IC designs to be evaluated. If the answer to the inquiry at decision block 326 is no, the methodology 310 moves to block 328 and ends. If the answer to the inquiry at decision block 326 is yes, the methodology 310 moves to block 314 to apply the methodology 310 to a next IC design.

FIG. 4 depicts a sample section or snippet of an IC design 410 that illustrates CPPR. A portion of the pessimism introduced into a timing database can be attributed to additional pessimism built-in to address sequential logic pairs, such as, for example launch and capture flip flop pairs, FF1 and FF2. This additional pessimism can be removed, in-part, due to the fact that the launch and capture pair FF1, FF2, share a portion of a common clock path 440 from the clock root (CLK) to the launch and capture flip flops FF1, FF2.

In STA, it is assumed that the launch flip flop (e.g., FF1) has a separate path to the clock root CLK than the capture flip flop (e.g., FF2). Thus, the two separate paths for launch and capture respectively have pessimism on the minimum and maximum ATs at each of the flip flops. However, as depicted in FIG. 4, if the launch flip flop FF1 and the capture flip flop FF2 share at least some portion of their clock path (e.g., common clock path 440), then the common clock path injects some additional/undue pessimism because it cannot possibly be both late and early simultaneously. Thus, a portion of the pessimism can be removed by identifying the segments of the common clock path 440 for each launch/capture pair FF1, FF2 throughout the IC design 410. If this pessimism is not removed, then the fabricated version of the IC design 410 can have a larger footprint than necessary, requiring more semiconductor substrate, and increasing cost. Power requirements and drain will likewise increase as each new gate adds a new additional drain on power. Consequently, operating frequency may need to be reduced, yielding a reduction in the performance of the IC design 410. While the marginal decreases in performance, power efficiency, and effective use of the substrate area can be relatively small for each chip, the losses and inefficiencies, in the aggregate, can be considerable for a production run of an IC product based on the design (being fabricated potentially tens of millions of times).

Referring still to FIG. 4 there is depicted a non-limiting example of how additional/unneeded pessimism can be introduced to the IC design 410 by the common clock path 440. The timing path of the IC design 410 includes a launch path 420 (or launch clock path 420) and a capture path 430 (or capture clock path 430). The launch path 420 includes c1→c2→c3→CP-to-Q of FF1→c5→FF2/D. The capture path 430 is c1→c2→c4→FF2/CP. Late and early derates are set for cells and nets while doing timing analysis in on-chip-variation mode. Timing derating means adding an extra margin to STA functionality to accommodate variation in timing parameters of gates (as they were characterized in a timing library). Timing libraries are characterized for a particular operating condition representing a combination of process, voltage and temperature (PVT). Cell delay is the amount of delay from input to output of a logic gate in a path. The values of cell delay can be taken from timing libraries or from SDF (standard delay format) files if they are available. Net delay is the amount of delay from the output of a cell to the input of the next cell in a timing path. Net delay is due to parasitic resistance and capacitance of net connection between cells. For setup analysis, a late check is performed for the launch clock path 420, and an early check is performed for the capture clock path 430. However, part of both the capture clock path 430 and the launch clock path 420 are the same (i.e., the common clock path 440) until node n1.

As shown in FIG. 4, the “1 ns” times denote the maximum delays (late delay numbers) and the “0.8 ns” numbers in green are min delays (early delay numbers). For this example, it can be assumed that the net delays are included in the numbers. For setup analysis, the delay in the launch clock path 420 is c1→c2→c3→FF1/CP, which corresponds to 1 ns+1 ns+1 ns=3 ns. The delay in the capture clock path 430 is c1→c2→c4→FF2/CP, which corresponds 0.8 ns+0.8 ns+0.8 ns=2.4 ns. Because of the common clock path 440, it is not realistic that the launch path 420 and the capture path 430 each have two different delays for the same analysis. Using the late and early timing numbers for the common clock path 440 creates unwanted pessimism in the timing analysis leading to difficulties in timing closure or overdesign. Thus, removal of this additional pessimism is necessary. In general, STA tools have various attributes to selectively enable clock path pessimism removal, including specifically common path pessimism removal (CPPR).

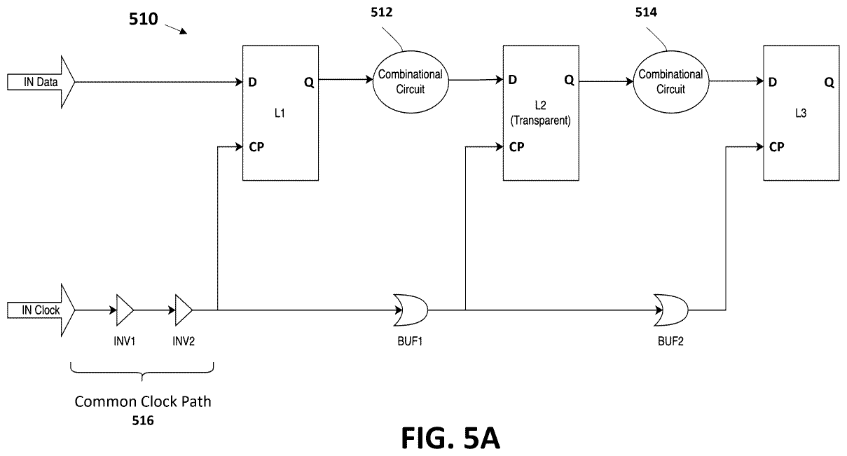

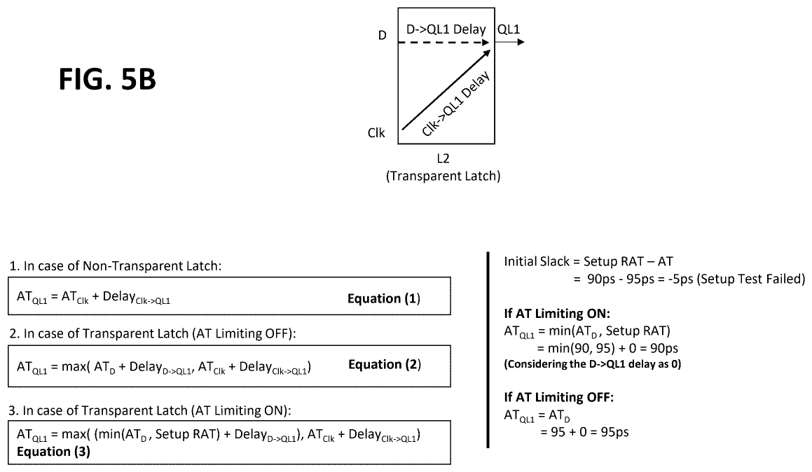

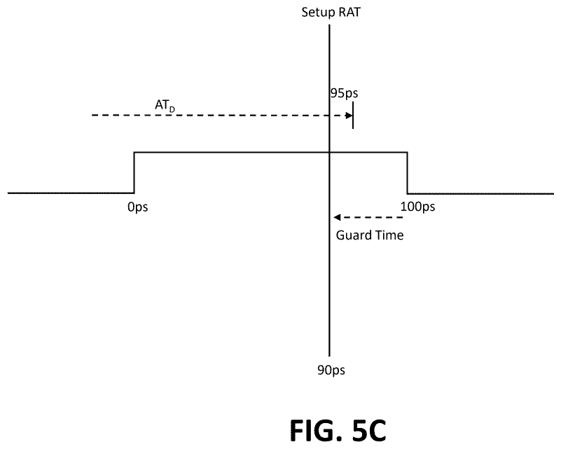

FIG. 5A depicts a section or snippet of an IC design 510 that illustrates how common clock path pessimism manifests in the IC design 510 where at least two of the flip flops or latches are in a dependent or interdependent relationship with one another. Two flip flops or latches are in a dependent or interdependent relationship with one another when an ability of one flip flop (or latch) to meet timing constraints of the IC design depends on the outputs of the other flip flop (or latch). In some embodiments of the invention, the “other” flip flop is transparent, and the “one” flip flop (or flip flops) is/are downstream from the “other” flip flop. The IC design 510 includes a first latch L1, a combinational logic circuit 512, a second latch L2, a combinational logic circuit 514, a third latch L3, a set of inverters (INV1, INV2), and a set of buffers (BUF1, BUF2), configured and arranged as shown. The combinational logic circuit 512 and the combinational logic circuit 514 each represents the various types digital circuits where the output is purely determined by its current inputs without any dependence on past inputs or previous states. Thus, for STA purposes, output(s) of a combinational logic circuit are a direct function of the input(s) at any given moment. L1 functions as the launch latch, and data will be captured at latches L2 and L3. A portion of the clock paths of the IC design 510 includes a common clock path 516 having the set of inverters INV1, INV2.

As previously noted herein, as part of performing timing analysis on the IC design, the IC design 510 can be modeled as a timing graph with gate-pins and wire-pins denoted by timing nodes. Each connection from an input pin (source node) to an output pin (sink node) is denoted by a directed timing edge in the graph. Generally, timing analysis involves calculating delay through the edges or paths between a chip input and a chip output to determine the speed of propagation of signal transitions at different components (e.g., gates, wires, latches) of the chip. Generally, AT at a given point refers to either the latest (in LATE mode) or earliest (in EARLY mode) time at which the voltage at the point reaches half of the maximum voltage. To account for on-chip and environmental variations (e.g., temperature, battery level), STA can be used to express AT as a range given by (early mode arrival time, late mode arrival time). Many known tests (e.g., setup test, hold test) can be performed as part of the timing analysis. The tests examine the worst-case scenario in most cases. Thus, for example, the setup test determines if the late mode AT at the input of a data node of a device occurs before the early mode AT at the clock node so that the data is captured correctly. The issue of pessimism arises in timing analysis tests when early mode and late mode are considered for the same edge (e.g., the common clock path 516). For example, in the setup test example, if the data input and the clock input shared an edge (e.g., the common clock path 516), the test uses late mode AT with respect to the data input, which considers late mode delay through that edge, as well as early mode AT with respect to the clock input, which considers early mode delay through that same edge. This is referred to as common path pessimism (CPP). Common path pessimism removal (CPPR) is a technique for adjusting timing slack (crediting some time back to the edge) to account for the CPP (i.e., “additional” pessimism) associated with the edge. There are a number of CPPR algorithms that remove the additional or unneeded pessimism that results from having a common clock path (e.g., common clock path 516).

In general, a timing analysis performed on the IC design 510 that includes CPPR evaluations would be applied to each of the latches L1, L2, L3 individually under an assumption that the latches L1, L2, L3 function substantially independently of one another, and therefore a computation of the necessary CPPR adjustment for a CPPR candidate location (e.g., a candidate pin) of the IC design 510 is substantially independent of the computation of the necessary CPPR adjustments for the other CPPR candidate locations of the IC design 510 (e.g., other candidate pins). However, the application of CPPR algorithms to the IC design 510 is made more challenging by the presence of circuit element dependencies or interdependencies that result from the presence of one or more transparent latches. In the IC design 510, at least L2 is implemented as a transparent latch, and L1 and L3 can be implemented as non-transparent latches. In general, a non-transparent latch only latches the outputs with a copy of the inputs on a designated clock edge (or a clock transition). In other words, the output AT of a non-transparent latch is always controlled by the clock, and more specifically by a designated clock edge/transition. A transparent latch allows its outputs to follow its inputs while the latch is in the active state (i.e., the clock sign is high). In other words, for a transparent latch, as long as the clock signal is active, data can flush through the transparent latch and impact the output AT of the transparent latch. Thus, for transparent latch L2, the AT of the signal at the latch output is controlled not only by the clock but also by the movement of data through the latch.

The presence of transparent latches complicates the application of CPPR to the IC design 510 because the assumption that the latches L1, L2, L3 function substantially independently of one another is no longer valid where L2 is implemented as a transparent latch. More specifically, the changes to the timing computations caused by the transparency of latch L2 is that the slack computation or the AT of the signal (D) at latch L3 is dependent on transparent latch L2. Although the AT of signal D at latch L3 is always dependent on latch L2 regardless of latch L2's transparency, with the introduction of transparency at latch L2, it can dynamically update AT and the slack of the signal (D) at latch L3 in between the CPPR analysis. This may counter any decision to compute CPPR credit on latch L3 because of the slack cutoff. The decision of computing CPPR credit on L3 is dependent on the transparent latch L2. The latch-dependency issues become more prominent when more than one transparent latch is in the IC design 510, for example, where the IC design 510 includes one or more series of cascaded transparent latches. For ease of illustration and explanation, one transparent latch L2 is depicted in the IC design 510. However, it is understood that the embodiments of the invention described herein apply to IC designs having any number of dependent/interdependent circuit elements (or latches).

FIGS. 5B and 5C depict additional details of how the transparent latch L2 and/or the non-transparent latches L1, L3 can be implemented in accordance with embodiments of the invention. In some embodiments of the invention, transparency functionality can be provided by either enabling or disabling AT limiting functionality of the latch. As shown in FIG. 5B, Equation (1) depicts an equation for computing the AT associated with the data output of a non-transparent latch. Equation (2) depicts an equation for computing the AT associated with the data output of a transparent latch where AT limiting functionality has been turned off. Equation (3) depicts an equation for computing the AT associated with the data output of a transparent latch where AT limiting functionality has been turned on to achieve transparency in the latch. FIG. C depicts clock signals and data AT associated with operation of a transparent latch.

Referring generally to FIGS. 5B and 5C, CPPR stands for common path pessimism removal. The static timing analysis is based on a worst-case analysis. In setup analysis, it uses the slowest possible launch path and fastest capture path. For AT limiting functionality, in normal non-transparent latches, there is a clock (Clk) to Q flushing. However, in the case of transparent latches, there is a D→Q flushing as well. Thus, whichever path earlier will determine the output AT at the Q output of L1. If, for example, there is a setup test failure, the data arrives after the trailing edge of the clock. Thus, in order to not to penalize the subsequent path, a Clk→Q flushing. Otherwise, if there is no setup test failure, the data is flushed from D→Q. A problem can arrive when there is a setup test failure and the associated setup CPPR adjust is greater than the slack value. Thus, pre-CPPR due to setup test failure, an AT limited output will be seen at the Q pin of L2. But, after applying the CPPR adjust, there is now a positive slack, and, due to that positive slack, a D→Q flushing will happen. Thus, if AT limiting is turned ON, a different arrival time will be seen at the Q pin of L2 pre-CPPR and post-CPPR. This creates a pessimism for the downstream path, and the associated AT. This AT change will change the slacks in the downstream path, and some latches for the CPPR calculation might be skipped on the basis of the slack cut-off. Existing STA tools do not update the AT during the CPPR; the only focus on the RATs.

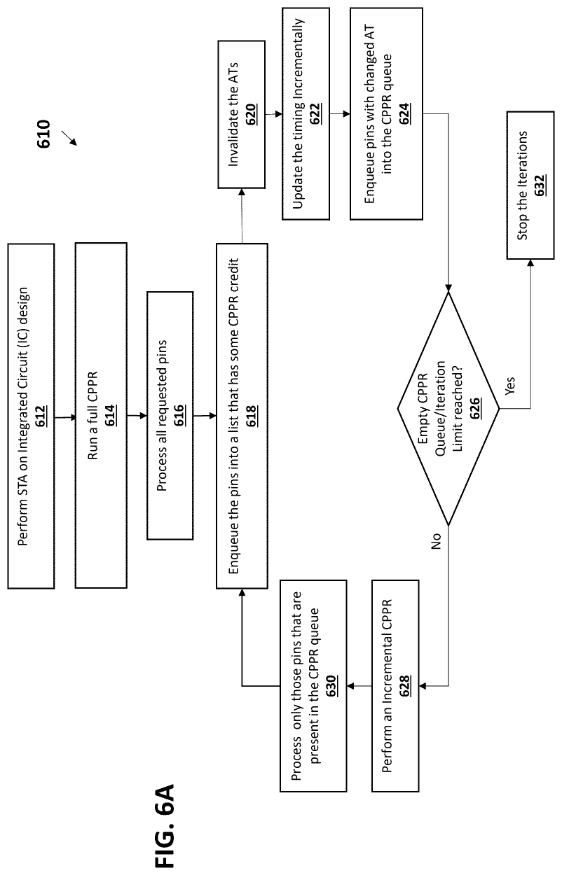

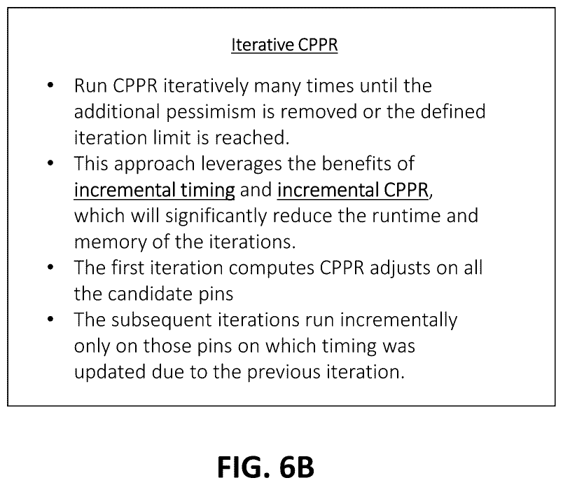

To address the challenges associated with using CPPR to remove additional pessimism from an IC design that includes transparent latch functionality, embodiments of the invention provide computing systems, computer-implemented methods, and computer program products (e.g., EDA tools) that implement IC design techniques configured and arranged to reduce “additional” pessimism from CPPR operations performed during STA. Some embodiments of the invention provide an “iterative” APR approach (e.g., iterative CPPR functionality 222 shown in FIG. 2) to remove unneeded or unwanted pessimism from a timing analysis. In accordance with embodiments of the invention the iterative APR approach includes running CPPR iteratively many times on an IC design until the additional pessimism is removed or a defined iteration limit is reached. The iterative APR approach is operable to leverage the benefits of incremental and parallel processing support for both timing and CPPR analysis, which will significantly reduce the runtime and memory of the iterations. The first iteration is operable to compute CPPR adjustments on all the candidate pins, and the subsequent iterations will run incrementally only on those pins on which timing was updated due to the previous iteration. Additional details of how an “iterative” APR approach (e.g., iterative CPPR functionality 222) can be implemented in accordance with embodiments of the invention are depicted in FIGS. 6A and 6B and described subsequently herein.

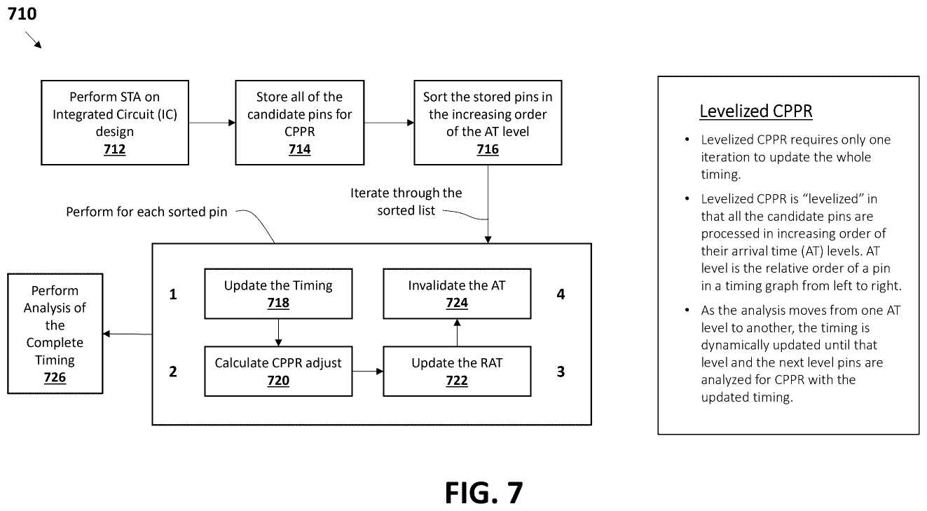

Some embodiments of the invention provide a “levelized” APR approach (e.g., levelized CPPR functionality 224 shown in FIG. 2) to remove unneeded or unwanted pessimism from a timing analysis. A levelized APR approach in accordance with aspects of the invention includes only one iteration to update the whole timing. The levelized APR approach works in a levelized manner, i.e., all of the candidate pins are processed in increasing order of their AT levels. As previously noted, the AT level is the relative order of a pin in a timing graph from left to right. As the levelized APR approach moves from one AT level to another, the timing is dynamically updated until that level and the next level pins are analyzed for CPPR with the updated timing. Additional details of how an “levelized” APR approach (e.g., levelized CPPR functionality 224) can be implemented in accordance with embodiments of the invention are depicted in FIG. 7 and described subsequently herein.

FIG. 6A depicts a computer-implemented methodology 610 (also referred to herein as a methodology 610) operable to be implemented using an EDA tool that incorporates the STA functionality 210 (shown in FIG. 2). More specifically, the methodology 610 is a non-limiting example of how the iterative CPPR functionality 222 of the APR functionality 220 (shown in FIG. 2) can be implemented in accordance with embodiments of the invention. The methodology 610 will be described with reference to its application to performing timing analysis on the IC design 510 shown in FIG. 5A. The methodology 610 begins at block 612 by performing STA on an IC design, and more specifically on the IC design 510. At block 614, the STA includes running a full CPPR analysis on the IC design 510, which includes running CPPR on each of the latches L1, L2, L3, substantially in parallel, to generate at block 616 candidate pins for pessimism reduction. At block 618, the pins that receive CPPR adjust are enqueued into a list. For example, on the first iteration of the methodology 610, L1 & L3, which are non-transparent, do not need a CPPR adjustment or do not receive a CPPR adjustment because their slack is above the cut-off. However, L2, which is transparent and has slack under the cutoff, will receive a CPPR adjustment. Thus, on the first iteration of the methodology 610, candidate pin(s) of L2 are enqueued at block 618, and at block 620, the ATs associated with L2 are invalidated, which means that during the current iteration, the timing is not actually updated, it is instead just marked invalid for now and is updated later on when all of the pins of the current iteration have been processed. At block 622 the whole timing is updated incrementally, which means that all of the pins downstream of the pins that received a timing change in the current iteration will now become updated with the current timing of the L2/Q pin.

At block 624, the pins with changed ATs are enqueued into a CPPR queue, which is a queue used by the disclosed incremental CPPR such that the CPPR algorithm will only run on those pins which are present in the CPPR queue. Thus, after the first iteration of the methodology 610, all of the pins with the changed AT are in the CPPR queue. From block 624, the methodology 610 moves to decision block 626 to evaluate whether or not the CPPR enqueue is empty or the iteration limit has been reached. If the answer to the inquiry at decision block 626 is yes, the methodology 610 moves to block 632, stops the iterations, and the methodology 610 ends. If the answer to the inquiry at decision block 626 is no, the methodology 610 moves to blocks 628, 630 and performs an incremental CPPR, which means that a CPPR algorithm will only be performed on the pins that are present in in the CPPR queue. From block 630, the methodology 610 returns to block 618 to perform a next iteration of blocks 618, 620, 622, 624, and 626 on the pins found in the CPPR queue at the last iteration of decision block 626. For example, on the IC design 510, the methodology 610 will again compute CPPR credit on the (D) pin of the L3 latch because it now may become a candidate of CPPR due to the update in the downstream ATs because of L2's transparent behavior.

A summary of the operation of the computer-implemented methodology 610 is provided in FIG. 6B, which describes that the CPPR algorithm is run iteratively many times until the additional pessimism is removed or the defined iteration limit is reached. The iterative APR approach is operable to leverage the benefits of incremental and parallel processing support for both timing and CPPR analysis, which will significantly reduce the runtime and memory of the iterations. The first iteration computes CPPR adjusts on all the candidate pins; and the subsequent iterations run incrementally only on those pins on which timing was updated due to the previous iteration.

FIG. 7 depicts a computer-implemented methodology 710 (also referred to herein as a methodology 710) operable to be implemented using an EDA tool that incorporates the STA functionality 210 (shown in FIG. 2). More specifically, the methodology 710 is a non-limiting example of how the levelized CPPR functionality 224 of the APR functionality 220 (shown in FIG. 2) can be implemented in accordance with embodiments of the invention. The methodology 710 will be described with reference to its application to performing timing analysis on the IC design 510 shown in FIG. 5A. The methodology 710 begins at block 712 by performing STA on an IC design, and more specifically on the IC design 510. At block 714, the methodology 710 stores all of the candidate pins for a CPPR into a list; and at block 716, the methodology 710 sorts that list according to the increasing order of AT levels because in the levelized approach, the methodology 710 is operable to ensure that the pin at level zero (0) should be computed before the pin at level one (1). For each sorted pin, the methodology 710 first updates the timing at block 718. In performing STA during IC design operations, to “update” timing means to refresh or recalculate the timing data and constraints based on changes made to the IC design or its environment. Updating timing in STA involves recalculating and verifying the timing characteristics of an IC design to ensure that it meets the required constraints and operates correctly after any changes or adjustments. Processes that update timing ensure that the timing analysis reflects the most current state of the IC design and provides accurate timing information for verification and optimization. Timing updates can involve but are not limited to reflecting IC design changes, recalculating delays, timing constraint changes, checking for timing violations, optimization of timing information feedback, and tool synchronization. With respect to IC design changes, when modifications are made to the IC design, such as changes in logic gates, routing, or component placement, the timing analysis needs to be updated to account for these changes. With respect to recalculating delays, the timing analysis tool (e.g., STA functionality 210 shown in FIG. 2) recalculates propagation delays, setup and hold times, and other timing parameters based on the updated IC design. These recalculations includes evaluating changes in signal paths, delays introduced by new components, or adjustments in timing constraints. With respect to timing constraint changes, if there are updates to timing constraints, such as clock periods, setup and hold times, or other timing requirements, these changes must be incorporated into the timing analysis. The tool (e.g., STA functionality 210 shown in FIG. 2) updates the timing checks to reflect the new constraints. With respect to checking for timing violations, after updates, the STA tool (e.g., STA functionality 210 shown in FIG. 2) re-evaluates the IC design to check for timing violations, which can include checking whether any paths now exceed the setup or hold time requirements or if there are any new timing issues introduced by recent changes. With respect to the optimization of timing information feedback, updating timing provides feedback on the effectiveness of recent IC design optimizations or changes to help identify areas where further adjustments are needed to meet timing constraints. With respect to tool synchronization, timing updates ensure that internal data of the STA tool (e.g., STA functionality 210 shown in FIG. 2), including netlist and delay information, is synchronized with the latest version of the IC design files.

For each sorted pin, subsequent to the operations at block 718, the methodology 710 calculates the CPPR adjust (or CPPR adjustments) for that pin (block 720), updates the pin's RAT (block 722), and invalidate its AT at its Q pin (block 724) (i.e., the calculated or assumed timing information for that pin is marked as no longer accurate or valid based on certain changes or conditions that affect the timing analysis of the IC design). Similar to the operations at block 620 of the methodology 610, the timing is not actually updated at block 724, it is instead just marked invalid for now and is updated later (e.g., at block 718 on the next sorted pin evaluation, or at block 726 after all of the sorted pins have been evaluated and processed. The methodology 710 then moves to the next pin, performs the operations at blocks 718, 720, 722, 724 for the next pin, and the operations on the next pin will see the impact of the updates of the previous pin(s). And the analysis of the current PIN updates the timing again. In this way, the levelized approach reflected in the methodology 710 ensures that when each pin is processed, it is processed on the updated netlist, and the levelized iteration is maintained by the sorted list or by this sorted queue. After the pins have been analyzed, the methodology moves to block 726 and performs an analysis of the complete timing adjust and update the whole timing for the IC design 510 if there's any change. In this manner, the methodology 710 can ensure that the CPPR adjust on the L3 latch should be computer after the transparent latch L2 so that the effect of L2's transparency behavior can be seen on the latch L3.

A summary of the operation of the methodology 710 is provided in FIG. 7, which describes that the levelized CPPR algorithm requires only one iteration to update the whole timing. The levelized CPPR approach is “levelized” in that all the candidate pins are processed in increasing order of their arrival time (AT) levels. AT level is the relative order of a pin in a timing graph from left to right. As the analysis moves from one AT level to another, the timing is dynamically updated until that level and the next level pins are analyzed for CPPR with the updated timing.

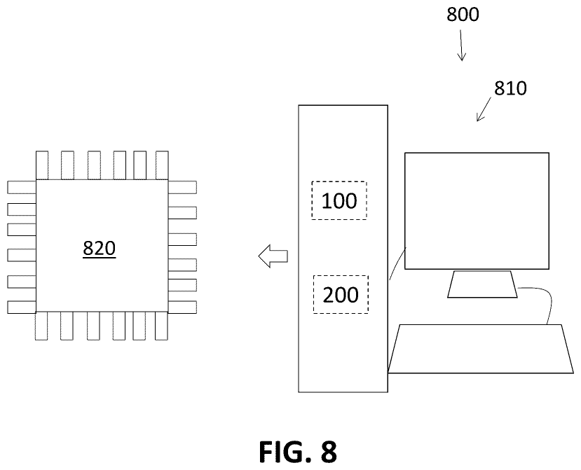

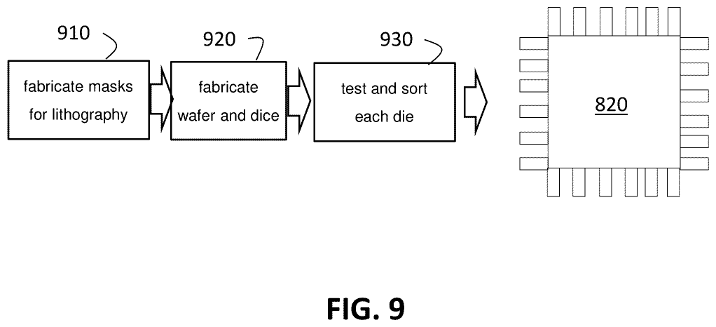

FIG. 8 is a block diagram of a system 800 to perform various IC design operations, including executing the code block 200 operable to implement the novel additional pessimism removal functionality described herein. The system 800 includes processing circuitry 810 used to generate the design that is ultimately fabricated into an IC 820. The steps involved in the fabrication of the IC 820 are well-known and briefly described herein. Once the physical layout is finalized, based, in part, on the low-latency HSS operations according to embodiments of the invention to facilitate optimization of the routing plan, the finalized physical layout is provided to a foundry. Masks are generated for each layer of the IC based on the finalized physical layout. Then, the wafer is processed in the sequence of the mask order. The processing includes photolithography and etch. This is further discussed with reference to FIG. 9.

FIG. 9 is a process flow of a method of fabricating the IC 820 according to exemplary embodiments of the invention. Once the physical design data is obtained, the IC 820 can be fabricated according to known processes that have been previously described herein, and that are generally described with reference to FIG. 9. Generally, a wafer with multiple copies of the final design is fabricated and cut (i.e., diced) such that each die is one copy of the IC 820. At block 910, the processes include fabricating masks for lithography based on the finalized physical layout. At block 920, fabricating the wafer includes using the masks to perform photolithography and etching. Once the wafer is diced, testing and sorting each die is performed, at block 930, to filter out any faulty die.

Thus it can be seen from the foregoing detailed description that embodiments of the invention provide improvements to how CPPR analysis can be performed for IC design operations where some or all of the relevant circuit elements have certain type of timing performance dependencies. Current CPPR algorithms work independently on all the candidate pins and apply CPPR credit to them if a common node is found in the clock path of the launch and capture latch. With the use of transparent latches in series with clock bounding, known approached to applying CPPR algorithms can leave some additional pessimism in the design as the CPPR adjust on two separate pins are no longer independent. CPPR credit on one pin can impact the slacks on other downstream latches that can change the amount of CPPR credit given to already eligible pins; and make more pins eligible for CPPR analysis by bringing them under the cut-off.

Some embodiments of the invention provide an iterative approach to performing CPPR analysis where certain types of dependencies or interdependencies are present between at least two circuit elements. In some embodiments of the invention, the circuit elements are latches, and at least one of the latches is a transparent latches. An iterative approach to applying CPPR analysis in accordance with embodiments of the invention runs CPPR iteratively many times until the additional pessimism is removed or reached the defined iteration limit. This approach will leverage the benefits of incremental timing and incremental CPPR which will significantly reduce the runtime and memory of the iterations. The first iteration will compute CPPR adjusts on all the candidate pins, and the subsequent iterations will run incrementally only on those pins on which timing was updated due to the previous iteration. A levelized approach to applying CPPR analysis in accordance with embodiments of the invention is approach caters to the same purpose as the iterative approach but requires only one iteration to update the whole timing performance. The levelized approach works in a levelized manner, i.e., all of the candidate pins are processed in increasing order of their AT levels. AT level is the relative order of a pin in a timing graph from left to right. As the evaluation moves from one AT level to another, then the timing is dynamically updated until that level and the next level pins are analyzed for CPPR with the updated timing.

Features of embodiments of the invention include, but are not limited to novel methods of applying CPPR adjust on two latches are no longer independent. The novel methods will remove additional pessimism created due to transparent latches in series. The novel methods can only remove more pessimism and never reduce the pessimism. In the novel method that provides an iterative CPPR approach, each iteration will update the timing that may create additional pessimism. The next CPPR iteration will work on removing that. In the novel method that provides a levelized CPPR approach, timing is updated dynamically as CPPR adjust is applied on a particular pin, and additional pessimism is accounted or in the first CPPR analysis on the pin itself.

Features of embodiments of the invention further include a computer-implemented method for removing pessimism in static timing analysis. The computer-implemented method includes adjusting common clock path pessimism removal (CPPR) on two or more latches, and removing additional pessimism created due to transparent latches in a series. The computer-implemented method further includes dynamically updating timing as CPPR adjusting is applied on a predetermined pin and additional pessimism is accounted in the first CPPR analysis on the pin itself.

In addition to any one or more of the features described herein, the computer-implemented method of claim 1 further includes updating the timing for a first iteration that creates additional pessimism; and removing the additional pessimism during a second iteration.

In addition to any one or more of the features described herein, the two latches are no longer independent.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about”can include a range of ±8% or 5%, or 2% of a given value.

As used herein, in the context of machine learning algorithms, the terms “input data,” and variations thereof are intended to cover any type of data or other information that is received at and used by the machine learning algorithm to perform training, learning, and/or classification operations.

In the context of IC design, the terms “CPPR adjust” and equivalents thereof refer to the adjustment of the CPPR parameter, which is used to manage and control the pessimism in timing analysis by adjusting the estimates for delays along critical paths in the IC design, thereby helping to reduce the overly conservative estimates that might affect the timing analysis, leading to more accurate performance evaluations and optimizations. Thus, CPPR adjust helps in fine-tuning the timing models to improve the reliability and performance of the IC design by addressing the critical path, which is the longest path that a signal travels through a circuit, as well as the pessimistic path and path reductions. The critical path in an IC design is the sequence of logic gates or elements that determines the maximum speed at which the IC design circuit can operate. If the critical path is too long, the IC design's performance is limited. In timing analysis, a pessimistic path is one where timing constraints are considered more conservative, often including additional margin to account for variability and uncertainties in manufacturing. Path reduction techniques target to shortening the critical path by optimizing the IC design, which can involve fine-tuning circuit elements of the IC design, adjusting timing parameters, or redesigning parts of the IC design to reduce delays. The fine tuning adjustments that can be performed when performing CPPR adjust include modifying the transistor sizes or gate delays; optimizing the placement and routing of the circuit elements; and/or adjusting clock speeds or timing margins.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It will be understood that those skilled in the art, both now and in the future, may make various improvements and enhancements which fall within the scope of the claims which follow.

What is claimed is:

1. A computer-implemented method of analyzing timing constraints of a component-under-design (CUD), the computer-implemented method comprising:
performing an initial iteration of a common path pessimism removal (CPPR) analysis on candidate circuit elements of the CUD;
wherein the candidate circuit elements comprise inputs and outputs;
wherein a subset of the candidate circuit elements comprise a first circuit element and a second circuit element, wherein an ability of the second circuit element to meet timing constraints of the CUD depends on the outputs of the first circuit element;
storing an initial list of the inputs and the outputs for which timing performance was adjusted during the initial iteration; and
applying a second iteration of the CPPR analysis to the initial list of the inputs and the outputs.

2. The computer-implemented method of claim 1, wherein the initial iteration of the CPPR analysis is performed substantially in parallel on each of the candidate circuit elements of the CUD.

3. The computer-implemented method of claim 1, wherein the computer-implemented method further comprises, responsive to the second iteration of the CPPR analysis, storing a second list of the inputs and the outputs for which timing performance was adjusted during the second iteration.

4. The computer-implemented method of claim 3, wherein the computer-implemented method further comprises, responsive to a determination that a maximum number of iterations of the CPPR analysis have been performed, ending the computer-implemented method.

5. The computer-implemented method of claim 3 further comprising, responsive to a determination that none of the inputs and none of the outputs received adjusted timing performance during an iteration of the CPPR analysis applied to the candidate circuit elements of the CUD, ending the computer-implemented method.

6. The computer-implemented method of claim 3, wherein the first circuit element comprises a transparent circuit element.

7. The computer-implemented method of claim 6, wherein the transparent circuit element comprises a transparent latch that is operable to pass data while a clock signal applied to the transparent latch is active.

8. A computer system comprising a processor system electronically coupled to a memory, wherein the processor system is operable to perform processor system operations operable to analyze timing constraints of a component-under-design (CUD), the processor system operations comprising:
performing an initial iteration of a common path pessimism removal (CPPR) analysis on candidate circuit elements of the CUD;
wherein the candidate circuit elements comprise inputs and outputs;
wherein a subset of the candidate circuit elements comprise a first circuit element and a second circuit element, wherein an ability of the second circuit element to meet timing constraints of the CUD depends on the outputs of the first circuit element;
storing an initial list of the inputs and the outputs for which timing performance was adjusted during the initial iteration; and
applying a second iteration of the CPPR analysis to the initial list of the inputs and the outputs.

9. The computer system of claim 8, wherein the initial iteration of the CPPR analysis is performed substantially in parallel on each of the candidate circuit elements of the CUD.

10. The computer system of claim 8, wherein the processor system operations further comprise, responsive to the second iteration of the CPPR analysis, storing a second list of the inputs and the outputs for which timing performance was adjusted during the second iteration.

11. The computer system of claim 10, wherein the processor system operations further comprise, responsive to a determination that a maximum number of iterations of the CPPR analysis have been performed, ending the processor system operations.

12. The computer system of claim 10, wherein the processor system operations further comprise, responsive to a determination that none of the inputs and none of the outputs received adjusted timing performance during an iteration of the CPPR analysis applied to the candidate circuit elements of the CUD ending the processor system operations.

13. The computer system of claim 10, wherein the first circuit element comprises a transparent circuit element.

14. The computer system of claim 13, wherein the transparent circuit element comprises a transparent latch that is operable to pass data while a clock signal applied to the transparent latch is active.

15. A computer program product comprising a computer readable program stored on a computer readable storage medium, wherein the computer readable program, when executed on a processor system, causes the processor system to analyzing timing constraints of a component-under-design (CUD) by performing processor system operations comprising:
performing an initial iteration of a common path pessimism removal (CPPR) analysis on candidate circuit elements of the CUD;
wherein the candidate circuit elements comprise inputs and outputs;
wherein a subset of the candidate circuit elements comprise a first circuit element and a second circuit element, wherein an ability of the second circuit element to meet timing constraints of the CUD depends on the outputs of the first circuit element;
storing an initial list of the inputs and the outputs for which timing performance was adjusted during the initial iteration; and
applying a second iteration of the CPPR analysis to the initial list of the inputs and the outputs.

16. The computer program product of claim 15, wherein the initial iteration of the CPPR analysis is performed substantially in parallel on each of the candidate circuit elements of the CUD.

17. The computer program product of claim 15, wherein the processor system operations further comprise, responsive to the second iteration of the CPPR analysis, storing a second list of the inputs and the outputs for which timing performance was adjusted during the second iteration.

18. The computer program product of claim 17, wherein the processor system operations further comprise, responsive to a determination that a maximum number of iterations of the CPPR analysis have been performed, ending the processor system operations.

19. The computer program product of claim 17, wherein the processor system operations further comprise, responsive to a determination that none of the inputs and none of the outputs received adjusted timing performance during an iteration of the CPPR analysis applied to the candidate circuit elements of the CUD, ending the processor system operations.

20. The computer program product of claim 17, wherein the first circuit element comprises a transparent circuit element.

21. The computer program product of claim 20, wherein the transparent circuit element comprises a transparent latch that is operable to pass data while a clock signal applied to the transparent latch is active.

22. A computer-implemented method of analyzing timing constraints of a component-under-design (CUD), the computer-implemented method comprising:
performing a common path pessimism removal (CPPR) analysis on candidate circuit elements of the CUD;
wherein the candidate circuit elements comprise inputs and outputs;
wherein a subset of the candidate circuit elements comprises a first circuit element and a second circuit element, wherein an ability of the second circuit element to meet timing constraints of the CUD depends on the outputs of the first circuit element;
storing a list of candidate inputs having a timing performance that is a candidate for CPPR;
sorting the list of the candidate inputs based at least in part on increasing arrival time (AT) levels associated with each of the candidate inputs of the list; and
for each of the candidate inputs of the list, beginning with a candidate input having a lowest AT level, applying a process comprising:
updating timing performance adjustments of an input-under-analysis (IUA);
computing CPPR adjustments of the IUA;
updating a required (RAT) associated with the CPPR adjustments; and
invalidating performance timing adjustments of downstream inputs.

23. The computer-implemented method of claim 22, wherein:
the first circuit element comprises a transparent latch; and
the transparent latch is operable to pass data while a clock signal applied to the transparent latch is active.

24. A computer system comprising a processor system electronically coupled to a memory, wherein the processor system is operable to perform processor system operations operable to analyze timing constraints of a component-under-design (CUD), the processor system operations comprising:
performing an initial common path pessimism removal (CPPR) analysis on candidate circuit elements of the CUD;
wherein the candidate circuit elements comprise inputs and outputs;
wherein a subset of the candidate circuit elements comprise a first circuit element and a second circuit element, wherein an ability of the second circuit element to meet timing constraints of the CUD depends on the outputs of the first circuit element;
storing a list of candidate inputs having a timing performance that is a candidate for CPPR;
sorting the list of the candidate inputs based at least in part on increasing arrival time (AT) levels associated with each of the candidate inputs of the list; and
for each of the candidate inputs of the list, beginning with a candidate input having a lowest AT level, applying a process comprising:
updating timing performance adjustments of an input-under-analysis (IUA);
computing CPPR adjustments of the IUA;
updating a required arrival time (RAT) associated with the CPPR adjustments; and
invalidating timing performance adjustments of downstream inputs.

25. The computer system of claim 24, wherein:
the first circuit element comprises a transparent latch; and
the transparent latch is operable to pass data while a clock signal applied to the transparent latch is active.
